(19) United States
(12) Patent Application Publication
(10) Pub. No.: US 2013/0205521 A1
(43) Pub. Date: Aug. 15, 2013

(54) DEVICE TO CLEAN BLOCKS OF MAGNETIC SEPARATORS

(71) Applicant: Maderson Marcelo SANTOS, Itabira (BR)

(72) Inventor: Maderson Marcelo SANTOS, Itabira (BR)

(73) Assignee: VALE S.A., Rio de Janeiro - RJ (BR)

(21) Appl. No.: 13/588,913

(22) Filed: Aug. 17, 2012

Related U.S. Application Data
(60) Provisional application No. 61/525,498, filed on Aug. 19, 2011.

(51) Int. Cl. B03C 1/28

(52) U.S. Cl. CPC B03C 1/284
USPC 15/93.1

(57) ABSTRACT

The present invention is related to a device to clean blocks of magnetic separators, wherein the device comprises a main body provided with a pneumatic system and a spatula associated to this main body through a fastener element.

The present invention refers to a pneumatic device particularly used to clean magnetic separator blocks avoiding incrustations in these blocks' gaps.

### BACKGROUND OF THE INVENTION

Despite the use of methods to avoid the contamination of the blocks of magnetic separators, more precisely the blocks' gaps, such contamination still occur due to factors inherent to the process and, as a result, the gaps are filled with incrustations.

Actually, the gaps of the magnetic separators blocks are cleaned in a very repetitive way, where the operator needs to apply multiple strokes of a hammer on a clean spatula to clean the incrustation in a block's gap. Each block has 80 gaps. Each magnetic separator has 27 blocks in the upper magnetic rotor and more than 27 in the bottom rotor, therefore, it takes a lot of time and hammer blows per gap to clean a magnetic separator.

In this sense, it is necessary to make available different kinds of process and tools for cleaning these gaps.

### SUMMARY OF THE INVENTION

Then, in order to overcome this problem the present invention provides a pneumatic device comprising a main body in which a spatula is fixed. The main body comprises the pneumatic system that pulses the spatula within the gap removing the incrustations.

### BRIEF DESCRIPTION OF THE DRAWINGS

FIG. 1 shows the spatula that is one of the device's elements;

FIG. 2 shows the fastener element that fixes the spatula attached to the main body;

FIG. 3 shows the main body of this device comprising the pneumatic system; and

FIG. 4 show the device to clean blocks of magnetic separators according to the present invention.

### DESCRIPTION OF PREFERRED EMBODIMENTS

The present invention relates to a device 10 to clean blocks of magnetic separators, more precisely the blocks' gaps.

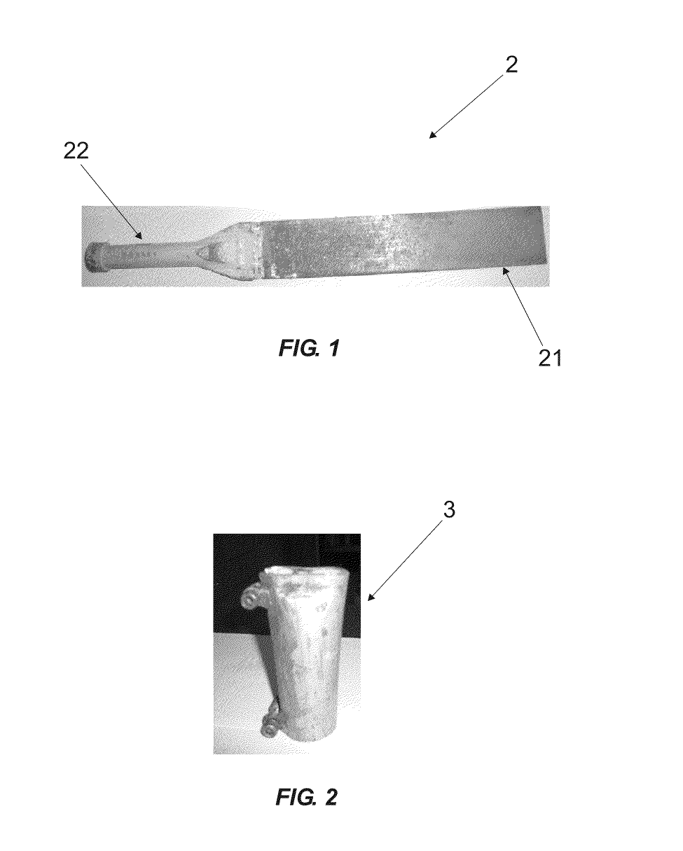

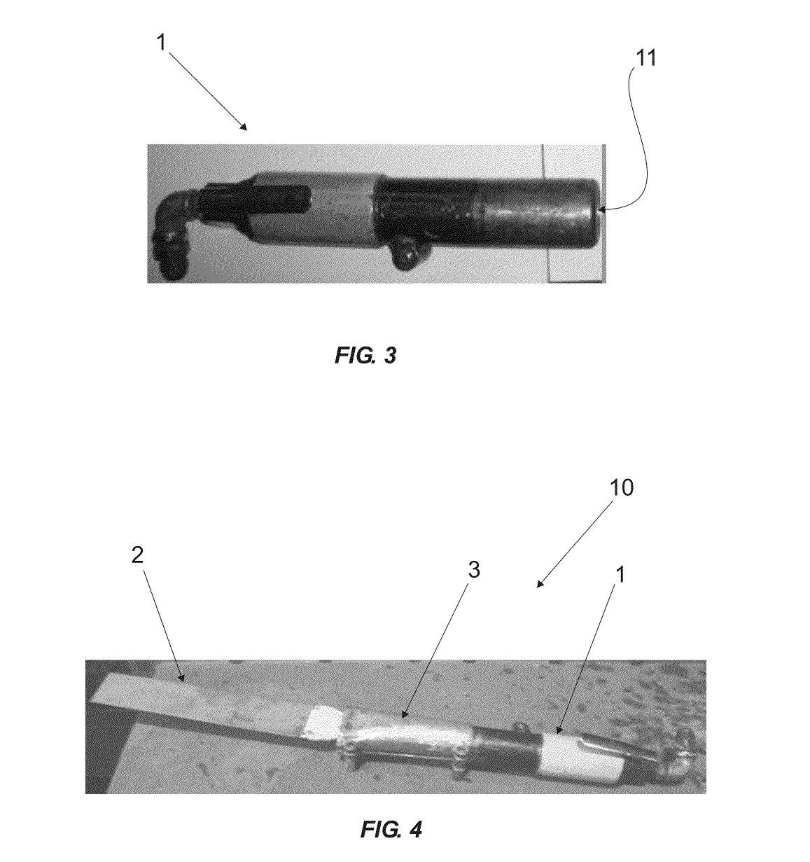

As illustrated by FIGS. 1 to 4, this device 10 comprises a main body 1 provided with a pneumatic system and a spatula 2 associated to this main body 1 through a fastener element 3.

The spatula 2 comprises a first edge 21 that contacts the blocks of magnetic separators to clean its gaps. This spatula 2 also comprises a second edge 22 that is associated to a cavity 11 in the main body 1. Specifically, the second edge 22 of the spatula 2 is positioned inside the cavity 11 of the main body 1.

According to FIG. 4, the fastener element 3 is concentrically attached to the spatula 2 and the main body 1, providing the joint of the second edge 22 of the spatula 2 within the main body 1.

The main body 1 comprises a pneumatic system that pulses the spatula 2 into linear movement in contact to the block. The spatula 2 is positioned inside a block's gap of a magnetic separator. With the pulse impact provided by the pneumatic system, the spatula 2 can remove the incrustations found in this gap.

This device 10 replaces the effort made by the operators by the pneumatic system.

Another advantage is that the device allows the cleaning of the gap's even with fine material deposited in the blocks.

1. A device to clean blocks of magnetic separators, the device comprising:
a main body provided with a pneumatic system; and
a spatula associated to this main body through a fastener element.

2. The device according to claim 1, wherein the spatula comprises:
a first edge that contacts the blocks of the magnetic separators to clean; and
a second edge that is associated with a cavity in the main body.

3. The device according to claim 2, wherein the fastener element is able to join the second edge of the spatula to the main body.

4. The device according to claim 3, wherein the fastener element is concentrically attached to the spatula and the main body.

5. The device according to claim 1, wherein the pneumatic system of the main body pulses the spatula into linear movement in contact to the block.
